(19) United States
(12) Patent Application Publication
(10) Pub. No.: US 2015/0323682 A1
(43) Pub. Date: Nov. 12, 2015

(54) Radiation Detection Apparatus Having A Doped Scintillator And A Pulse Shape Analysis Module And A Method Of Using The Same

(71) Applicant: Saint-Gobain Ceramics & Plastics, Inc., Worcester, MA (US)

(72) Inventors: Kan Yang, Solon, OH (US); Peter R. Menge, Novelty, OH (US)

(21) Appl. No.: 14/706,665

(22) Filed: May 7, 2015

Related U.S. Application Data
(60) Provisional application No. 61/991,016, filed on May 9, 2014.

(51) Int. Cl. G01T 1/20; G01T 3/06

(52) U.S. Cl. CPC G01T 1/20; G01T 3/06

(57) ABSTRACT

A radiation detection apparatus can include a scintillator, a photosensor optically coupled to the scintillator, and a control module electrically coupled to the photosensor. The control module can include a pulse shape analysis module that is configured to discern or discriminate between different types of radiation or radiation sources. The scintillator can include a base composition with a particular dopant that aids in the pulse shape analysis. In one embodiment, the radiation detection analysis module can more readily discriminate different types of radiation or radiation sources, such as gamma radiation from background alpha particles or neutrons. The dopant may include a monovalent or divalent metal, and the pulse shape analysis may involve transforming data.

### CROSS-REFERENCE TO RELATED APPLICATIONS

The current application claims priority from U.S. Provisional Patent Application No. 61/991,016, filed May 9, 2014, entitled “Radiation Detection Apparatus Having a Doped Scintillator and a Pulse Shape Analysis Module and a Method of Using the Same”, naming as inventors Kan Yang et al., which is incorporated by reference herein in its entirety.

### FIELD OF THE DISCLOSURE

The following is directed to radiation detection apparatuses, and more particularly to radiation detection apparatuses having doped scintillators and pulse shape analysis modules and methods of using the same.

### BRIEF DESCRIPTION OF THE RELATED ART

Many materials that are used for scintillators include undesired impurities. The undesired impurities generally are found in the starting materials used to make the scintillators and affect the properties of the scintillator. While purification can reduce the amount of undesired impurities, the cost of such purification may not be commercially feasible. The industry desires improvements in radiation detection apparatuses having scintillators not requiring expensive purification processes.

### BRIEF DESCRIPTION OF THE DRAWINGS

Embodiments are illustrated by way of example and are not limited by the accompanying figures.

FIG. 1 includes a schematic depiction of a sonde including a radiation detection apparatus in accordance with an embodiment.

FIG. 2 includes a schematic depiction of a sonde including a radiation detection apparatus in accordance with another embodiment.

FIG. 3 includes a schematic view of a portion of a control module in accordance with an embodiment.

FIG. 4 includes a flow chart depicting an exemplary method of using a particular radiation detection apparatus.

FIG. 5 includes a scatter plot of a pulse shape discrimination parameter as a function of Gamma Equivalent Energy for a radiation detection apparatus that includes a scintillator that is made of LaBr3:Ce.

FIG. 6 includes a scatter plot of a pulse shape discrimination parameter as a function of Gamma Equivalent Energy for a radiation detection apparatus that includes a scintillator that is made of LaBr3:Ce, Sr.

FIG. 7 includes an illustration of a detector used in testing an example.

FIG. 8 includes an illustration of a neutron test set up using the detector in FIG. 7.

FIG. 9 includes a scatter plot of a pulse shape discrimination parameter as a function of Gamma Equivalent Energy for a radiation detection apparatus that includes an exemplary scintillator.

FIG. 10 includes a pulse shape discrimination spectrum of neutrons and gamma radiations obtained using the test set up of FIG. 9.

Skilled artisans appreciate that elements in the figures are illustrated for simplicity and clarity and have not necessarily been drawn to scale. For example, the dimensions of some of the elements in the figures may be exaggerated relative to other elements to help improve understanding of embodiments of the invention. The use of the same reference symbols in different drawings indicates similar or identical items.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings.

As used herein, the term, “Actinide” is intended to mean any one or more of the Actinides (Ac to Lr) in the Periodic Table of the Elements, the term “Lanthanide” is intended to mean any one or more of the Lanthanides (La to Lu) in the Periodic Table of the Elements, and the term “rare earth” or “rare earth element” is intended to mean any one or more of Y, Sc, and the Lanthanides.

The term “base compound,” with respect to a scintillator, is intended to mean a composition of the scintillator excluding a particular dopant. For example, Cs₂LiYCl₆:Ce can be co-doped with a Group 2 element, such as Sr, wherein such Group 2 element is the particular dopant. Thus, Ce is an activator, which is a specific type of dopant, but in this example, Ce is part of the base composition. The composition can be expressed as Cs₂LiYCl₆:Ce,Sr, where Sr is the particular dopant, and the corresponding base composition is Cs₂LiYCl₆:Ce or Cs2LiY₍₁₋ₐ₎CeₐCl₆, wherein 0<a<0.01.

As used herein Figure of Merit (FOM) can be used to determine how well peaks from different radiation can be resolved. FOM is defined by the following equation:

|(H₁−H₂)|/(FWHM₁+FWHM₂).

H₁, H₂, FWHM₁, FWHM₂ are all in units of the PSD parameter, and therefore, FOM is dimensionless. A higher value of FOM indicates that the peaks from different radiation can be resolved more readily. Unless stated explicitly stated otherwise, FOM is determined from readings taken at room temperature (e.g., 25° C.).

Group numbers corresponding to columns within the Periodic Table of Elements are based on the IUPAC Periodic Table of Elements, version dated Jan. 21, 2011.

The term “higher energy gamma radiation” is intended to mean gamma radiation which when captured by a scintillator produces scintillating light with an integrated signal corresponding to an energy of at least 1.4 MeV, and the “lower energy gamma radiation” is intended to mean gamma radiation which when captured by a scintillator produces scintillating light with an integrated signal corresponding to an energy lower than 1.4 MeV.

The term “in elemental form,” when referring to a chemical element, is intended to mean that the element is not part of a molecule having different elements. For example, C can be in the form of a molecule with another element, such as CH₄ or CO₂, or may exist as a collection of atoms that only include C that may or may have a corresponding crystalline structure, such as diamond or graphite. The former is not C in elemental form, whereas the latter is C in elemental form.

The term “targeted radiation” is intended to refer to a type of radiation or a radiation corresponding to a radiation source that can be captured by a scintillator in a radiation detection apparatus. The type of radiation is defined below. Different radiation sources that correspond to different photon energies for the same type of radiation. For example, ⁶⁰Co can emit gamma radiation corresponding to 1173 keV, and ¹³⁷Cs can emit gamma radiation corresponding to 662 keV. Hence, gamma radiation from ⁶⁰Co and gamma radiation from ¹³⁷Cs are examples of different targeted radiation.

The term “type of radiation” is intended to refer to each of gamma radiation, neutrons, alpha particles, beta particles, x-rays, or the like. For example, gamma radiation is a different type of radiation than neutrons; however, different energies of gamma radiation, such as corresponding to ⁶⁰Co and ¹³⁷Cs, are not considered different types of radiations.

The terms “comprises,” “comprising,” “includes,” “including,” “has,” “having,” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

The use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in textbooks and other sources within the scintillation and radiation detection arts.

Many scintillators include undesired impurities that can interfere with the proper operation of a radiation detection apparatus. In particular, a scintillator that includes a rare earth element typically includes an Actinide as an undesired impurity. Although nearly all of the Lanthanides are affected by many of the Actinides, the problem is particularly problematic with La and Ce with respect to Ac, Th, and U. Of these elements, La with respect to Ac is particularly problematic because La and Ac are difficult to separate. The effect is that a naturally occurring Actinide as an undesired impurity may make detection of relatively high energy gamma radiation more difficult to detect because alpha particles emitted by the Actinide may produce a signal that significantly overlaps or otherwise interferes with a signal that corresponds to gamma radiation.

In an embodiment, a dopant can be added to a base composition to form a scintillator that can help to improve the resolution of the signal used during pulse shape analysis to more readily discriminate between different types of radiation, different radiation sources, or both. In an embodiment, the dopant can be a divalent element or a monovalent element for a scintillator that has a base composition that includes a rare earth element. During pulse shape analysis, the dopant helps to provide better separation between gamma radiation and alpha particles. In a particular embodiment, the dopant can help in detecting high energy gamma radiation, such as at least 1.4 MeV, at least 1.7 MeV, or at least 2.0 MeV. In another embodiment, the gamma radiation is no greater than 17.6 MeV.

In another embodiment, a dopant can be added to a base composition to form a scintillator that improves the resolution of the signal used during pulse shape analysis to more readily discriminate between different targeted radiation, such as different types of radiation or different radiation sources. In a particular embodiment, the dopant can be a divalent element or a monovalent element for a scintillator that has a base composition that includes a rare earth element. A neutron sensitive may be included within the base composition of the scintillator, for example, an elpasolite, or may surround the scintillator, such as LiF. The neutron sensitive material can emit an alpha particle when a neutron is captured, and the alpha particle may be captured by the scintillator. During pulse shape analysis, the dopant helps to provide better separation between gamma radiation and the neutron. Hence, a radiation detection apparatus can be a dual-mode or multi-mode detector.

In an embodiment, the pulse shape analysis may be performed by a module within a control module for the radiation detection apparatus. The analysis may be performed using Fast Fourier Transform, a wavelet transform, another suitable transform, a ratio between different parts of the pulse, a rise time of the integrated pulse, a decay time of the scintillation pulse, or any combination thereof. The presence of the dopant within the scintillator helps to improve the pulse shape analysis by reducing the likelihood of misclassifying the radiation, determining the intensity of the radiation, reducing the time needed to classify the radiation, improving another suitable parameter, or any combination thereof.

Particular embodiments of the radiation detection apparatus and its operation are described in more detail below. After reading this specification, skilled artisans will appreciate that other embodiments can be used without departing from the scope of the concepts as described herein. Thus, the embodiments described herein are not intended to limit the scope of the appended claims.

Radiation detection apparatuses can be used in a variety of applications. Some applications can include well logging, medical imaging, port-of-entry detectors, scientific research, or the like. After reading this specification, skilled artisans will appreciate that features described below with respect to a particular application can be implemented with little or no change for a different application.

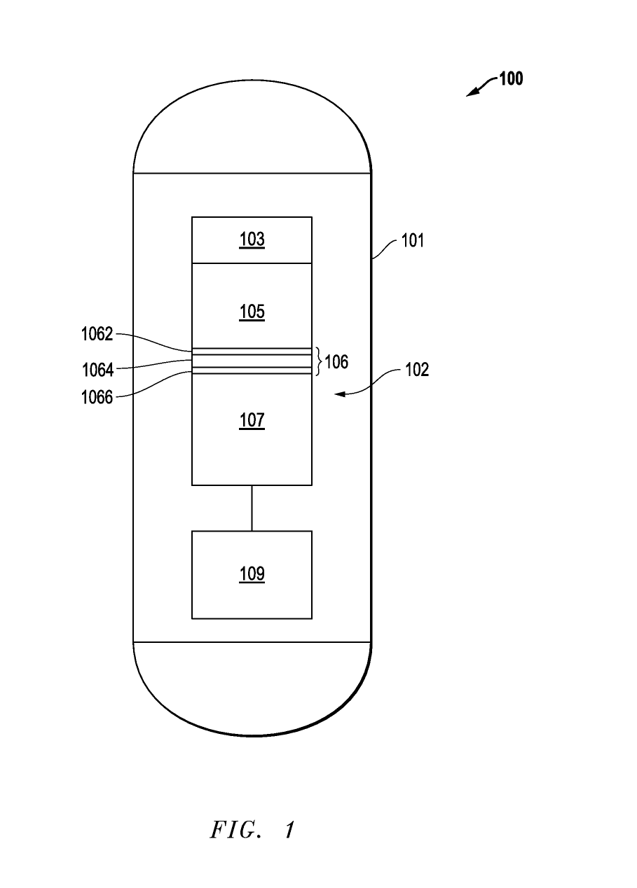

FIG. 1 includes a schematic depiction of a sonde 100 including a radiation detection apparatus 102 in accordance with an embodiment. The sonde 100 is a probe that can include a variety of devices that can be used in exploring regions and environments unsuitable for humans. One such application is exploratory drilling or well-logging applications in which holes can be drilled within the crust of the earth in order to explore and characterize rock structures below the surface. The sonde 100 may be a stand-alone tool or may be incorporated with other equipment near the distal end of a drill string. The other equipment can include a drill bit at the tip of the distal end, a turbine coupled to the drill bit, a generator or alternator coupled to the turbine, a battery or other energy storage device, a variety of sensors, such as rotational speed sensors, positional sensors, pressure sensors, and the like. The drill string includes sections of pipe that are screwed together and are manipulated at the proximal end of the drill string, which is at the surface. For example, the entire drill string can be rotated during drilling. Mud pumps outside the well bore pump mud along the drill string. The mud serves multiple purposes, one of which is to cause the rotor of the downhole turbine to spin. During drilling, many different parts of the drill string can be in motion. For example, the entire drill string may be rotating while mud is being pumped along the drill string which in turn causes the turbine to operate, which in turn causes the drill bit to rotate. The drilling can expose the radiation detection apparatus to be exposed to vibration or another noise that is generated near the radiation detection apparatus or is transmitted along any portion of the drill string, including from sources outside the drill string, such as the mud pumps. The significance of the noise is addressed later in this specification.

As illustrated, the sonde 100 can include a housing 101 for encapsulating and enclosing the radiation detection apparatus 102, can be part of a measurement-while-drilling (“MWD”) device. The housing 101 can be made of a material suitable for withstanding harsh environments including large temperature shifts from ambient conditions to temperatures in excess of 150° C., in excess of 200° C. or higher. The housing is sealed against pressures as high as 70 MPa (10,000 pounds per square inch). Additionally, the housing 101 may be capable of withstanding severe mechanical stresses and vibrations. As such, the housing 101 can be made of a metal or metal alloy material. Often, the housing 101 can be sealed to protect sensitive components inside from liquids, such as water, encountered in well-logging applications.

The radiation detection apparatus 102 can include materials and components suitable for detecting certain types of radiation in order to facilitate analyzing and characterizing rock structures surrounding the sonde 100, including properties such as the presence of hydrocarbon materials, presence of water, density of the rock, porosity of the geological formations, and the like. In a particular embodiment, the radiation detection apparatus 102 includes a calibration source 103, a scintillator 105, an optical coupling member 106, a photosensor 107, and a control module 109. The calibration source 103 can be coupled to the scintillator 105, and the scintillator 105 can be optically coupled to the photosensor 107, and the control module 109 can be unidirectionally or bidirectionally coupled to the photosensor 107. In another particular embodiment, the calibration source 103 may be a standalone unit and may be transported to different locations to calibrate different radiation detection apparatuses. Depending on the calibration source 103, the control module 109 may or may not be coupled to the calibration source 103.

In an embodiment, the calibration source 103 can be a component capable of emitting radiation at a known wavelength or spectrum of wavelengths suitable to cause the scintillator 105 to emit scintillating light. In another embodiment, the calibration source can also be capable of emitting neutrons or charged particles, such as alpha particles. In a particular embodiment, the calibration source 103 includes a radioactive isotope, such as cobalt 60, (⁶⁰Co), americium 241 (²⁴¹Am), cesium 137 (¹³⁷Cs), thorium 232 (²³²Th), or an isotope of another Lanthanide or Actinide element.

The scintillator 105 can be a material that responds to radiation by emitting scintillating light at a known wavelength or spectrum of wavelengths depending on the type of radiation captured by the scintillator 105. The scintillator 105 can have a base compound that includes a rare earth metal halide, a rare earth oxide, a rare earth silicate, a rare earth oxysulfide, or a rare earth aluminate. The scintillator 105 can include a base compound that includes an elpasolite. As previously discussed, many rare earth elements, and in particular, the Lanthanides, include one or more of the Actinides as undesired impurities. Of the rare earth elements, La and Ce tend to have relatively higher concentrations of the Actinides, and of the Actinides, Ac, Th, and U are the present in the highest concentrations. La is particular problematic as it is difficult to remove substantially of the Ac in a commercial feasible technique. Thus, a focus in this specification is to dope the scintillator with a dopant that will reduce the adverse affects or take advantage of the beneficial effects of Actinides when performing pulse shape analysis. The particular dopants will be addressed after describing some illustrative, non-limiting base compositions.

In another embodiment, the base compound may or may not have an activator, which is a particular type of dopant. In an embodiment, the activator can include Ce, Pr, or Tb, and in another embodiment, the activator can include Eu or Sm. The particular activator selected may be affected by the composition of the main constituents of the base compound and the desired wavelength of the peak emission of the scintillator. In an embodiment, the activator has a concentration of at least 10 parts per million atomic (ppma), at least 20 ppma, at least 50 ppma, or at least 110 ppma, and in another embodiment, the activator has a concentration of no greater than 1000 ppma, no greater than 700 ppma, no greater than 500 ppma, or at no greater than 300 ppma, wherein ppma is parts per million atomic. In a particular embodiment, the activator has a concentration in a range of 10 ppma to 1000 ppma, 20 ppma to 700 ppma, or 50 ppma to 500 ppma. When Ce is partly substituted for La, the Ce content may be as high as 40 atomic % of the total La and Ce content. In a particular embodiment, the Ce content can be in a range of 2 atomic % to 30 atomic % of the total La and Ce content.

In a particular embodiment, the scintillator 105 includes a base compound that has a general formula of REX₃, wherein RE is one or more rare earth elements, and X is one or more halogens, such as Cl, Br, and I. In a particular, the base compound has a formula of La₍₁₋ₐ₎CeₐBr_{3(1-c)}Cl_{3c}, wherein 0≦a≦1, and 0≦c≦1. When a=0 and c=0, the formula simplifies to LaBr₃, and when a=1 and c=0, the formula simplifies to CeBr₃. When c=1, the base compound is a chloride. The base compound can include a mixed halide, for example a compound that includes Br and Cl. The base compound can also include a mixture of La and Ce. In a particular embodiment, 0<a≦0.4. In a more particular embodiment 0.02≦a≦0.3.

In a particular embodiment, the scintillator 105 includes a base compound that has a general formula of M₃REX₆ or MRE₂X₇, wherein M is one or more Group 1 elements, RE is one or more rare earth elements, and X is one or more halogens, such as Br, Cl, and I. In a more particular embodiment, that base compound has a compound having a formula of Cs₂LiLa_{(1-a-b)}YₐCe_{b}Br_{6(1-c)}Cl_{6c}, wherein 0≦a≦1, 0≦b≦0.05, and 0≦c≦1. When a=0 and c=0, the formula simplifies to Cs₂LiLa_{(1-b)}Ce_{b}Br₆, which may be referred to as CLLB:Ce. When a+b=1 and c=1, the formula simplifies to Cs₂LiY_{(1-b)}Ce_{b}Br₆, which may be referred to as CLYC:Ce. In these particular embodiments, ⁶Li is a neutron sensitive material. Naturally occurring Li includes about 10% ⁶Li and 90% ⁷Li. The base composition can include naturally occurring Li or may include enriched Li, where the ⁶Li content is higher than the naturally occurring ⁶Li content.

As previously discussed, a scintillator having a base composition can further include a particular dopant that can assist in resolving data from a pulse shape analysis to discern or discriminate between different targeted radiation, such as different types of radiation or radiation sources. In an embodiment, the particular dopant can include a divalent element, such as a Group 2 element. In particular embodiment, the particular dopant is a compound of Sr, Ba, or a combination thereof. In another particular embodiment, the particular dopant is a compound of Ca. In another embodiment, the particular dopant can include a monovalent element, such as a Group 1 element. In particular embodiment, the particular dopant is a compound of Li, Na, or a combination thereof. In a further embodiment, the particular dopant is a compound of B or Bi. The particular dopant can include only one dopant or a combination of dopants.

The particular dopant can be added as a molecular compound where the anion is compatible with the base composition. For example, the particular dopant can be added as a metal halide when the base composition is a rare earth halide, and the particular dopant can be added as an oxide when the base composition includes oxygen, such as with a rare earth oxide (perovskite), a rare earth silicate, a rare earth garnet, and the like. In a further embodiment, the particular dopant has a melting or sublimation point that is about the same or higher than the melting or sublimation point of the base compound. In this manner, incorporation of the dopant is more likely to occur when the scintillator is formed from a melt. For example, when the base composition is LaBr₃:Ce, the particular dopant may include CaBr₂, SrBr₂, or BaBr₂. More Sr or Ba would be incorporated into the scintillator, as compared to Ca, as CaBr₂ has a melting point that is a little below the melting point of the base composition. When the base composition is LaCl₃:Ce, the particular dopant may include SrCl₂, or BaCl₂. In a particular embodiment, CaCl₂ may not be used as the particular dopant because base composition has a melting point more than 80° C. higher than the melting point of CaCl₂. After reading this specification, skilled artisans will be able to select a particular dopant that meets the needs or desires for a particular application.

In an embodiment, the particular dopant has a concentration of at least 10 ppma, at least 20 ppma, at least 50 ppma, or at least 110 ppma, and in another embodiment, the particular dopant has a concentration of no greater than 1000 ppma, no greater than 700 ppma, no greater than 500 ppma, or at no greater than 300 ppma, wherein ppma is parts per million atomic. In a particular embodiment, the particular dopant has a concentration in a range of 10 ppma to 1000 ppma, 20 ppma to 700 ppma, or 50 ppma to 500 ppma.

The radiation detection apparatus can further include a neutron sensitive material. The neutron sensitive material can allow the radiation detection apparatus to be a dual mode detector. The neutron sensitive material can be ⁶Li or ¹⁰B. ⁶Li makes up about 10% and ⁷Li makes up about 90% of the total naturally occurring Li; and ¹⁰B makes up about 20% and ¹¹Bi makes up about 80% of the total naturally occurring B. If needed or desired, Li or B may be enriched to increase the content of the neutron sensitive isotope. The neutron sensitive material can be part of the base composition of the scintillator 105. Some scintillators include a neutron sensitive material as part of the base composition, such CLYC:Ce and CLLB:Ce. The Li within the compound have a naturally occurring content of ⁶Li or may be enriched.

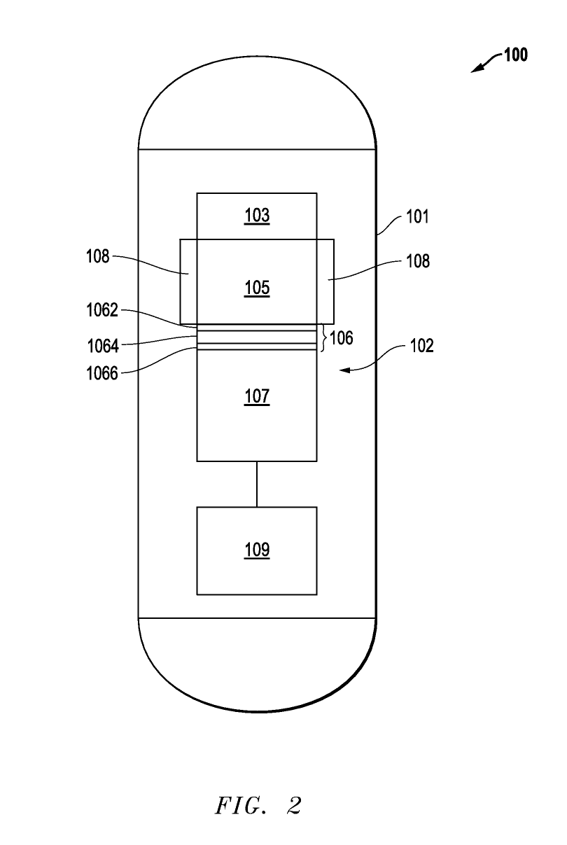

In another embodiment, the neutron sensitive material can be at least part of a component 108 that laterally surrounds the scintillator 105, as illustrated in FIG. 2. The component 108 can be in the form of a foil or a powder. The component can include a relatively stable form of a compound or element. An example includes ⁶LiF, ¹⁰B in elemental form, ¹⁰BN, ¹⁰B₄C, ¹⁰B₂O₃, or any combination thereof. In an embodiment, the components 108 can consist essentially of the compound or element, and therefore, the neutron sensitive material may not be embedded within a polymer matrix or suspended within a liquid. The component 108 may be in direct contact with the scintillator, or only a gas or vacuum may be disposed between the component 108 and the scintillator 105.

The optical coupler 106 can include a window 1064, a scintillator pad 1062 between the scintillator 105 and the window 1064, and a photosensor pad 1066 between the window 1064 and the photosensor 107. The window 1064 can be transparent or translucent to ultraviolet light, visible light, or both ultraviolet and visible light. In a particular embodiment, the window 1064 includes a glass, a sapphire, an aluminum oxynitride, or the like. Each of the scintillator pad 1062 and the photosensor pad 1066 can include a pad material, such as a silicone rubber or a clear epoxy.

The photosensor 107 can generate an electronic pulse in response to receiving scintillating light from the scintillator 105 or in response to noise. The photosensor 107 can be a photomultiplier tube (“PMT”), a semiconductor-based photomultiplier, or another suitable device that generates an electronic pulse in response to the scintillating light. The electronic pulse from the photosensor 107 can be transmitted to the control module 109.

The control module 109 can receive and process an electronic pulse from the photosensor 107 to enable a user to evaluate information gathered by the radiation detection apparatus 102. The control module 109 may include an amplifier, an analog-to-digital converter, a processor, a memory, another suitable component, or any combination thereof.

The control module 109 can also include electronic components that can send control signals to the calibration source 103 when the calibration source 103 includes an electronic component. The calibration source may be an electronic component, such as a light-emitted diode, or a radioactive material, such as ²³²Th, or a neutron generator tube. A controllable radiation shield (not illustrated) may be used if needed or desired if radiation from the radioactive material is to be shielded when the radiation detection apparatus 102 is not being calibrated. The control module 109 may be able to receive state information associated with the radiation detection apparatus 102. Thus, the state information can include state information of the radiation detection apparatus 102. When the radiation detection apparatus 102 is coupled to other equipment (for example, well drilling equipment), the state information may include state information of such other equipment. In an embodiment, the state information can include temperature or pressure of the sonde 100 or a location adjacent to sonde 100, operational parameters, such are turbine speed, drill bit speed, rotational speed of the drill string, or other suitable information. More details regarding the operation of the control module 109 with respect to processing electronic pulses from the photosensor 107 are described in more detail later in this specification. While the control module 109 can be contained within the sonde 101, the control module 109 may be located at the surface. When the control module 109 is within the sonde 101, the control module 109 may be powered by a downhole generator, alternator, or local energy storage device, such as a battery.

The radiation detection apparatus 102 can be used within the well bore to allow MWD or Wireline information to be obtained. U.S. Pat. No. 8,173,954, which is incorporated in its entirety, addresses operation of a radiation detection apparatus similar to that previously described. The radiation detection apparatus 102 in accordance with concepts as described herein is configured to provide further functionality not explicitly disclosed in U.S. Pat. No. 8,173,954.

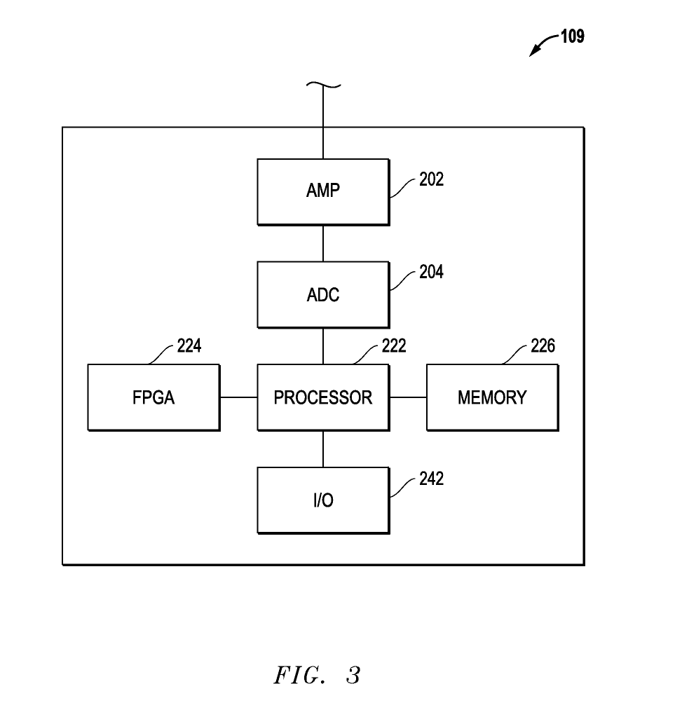

FIG. 3 includes a schematic diagram of an illustrative, non-limiting embodiment of the control module 109. As illustrated, an amplifier 202 is coupled to an analog-to-digital converter 204, which is coupled to a processor 222. The processor 222 is coupled to a programmable/re-programmable processing module (“PRPM”), such as a field programmable gate array (“FPGA”) 224 or application-specific integrated circuit (“ASIC”), a memory 226, and an input/output (“I/O”) module 242. The couplings may be unidirectional or bidirectional. The functions provided by the components are discussed in more detail below. In another embodiment, more, fewer, or different components can be used in the control module 109. For example, functions provided by the FPGA 224 may be performed by the processor 222, and thus, the FPGA 224 is not required. The FPGA 224 can act on information faster than the processor 222.

Before the FPGA 224 is used in well logging or another application, information regarding light output from the scintillator 105 when the scintillator is at different temperatures or other information is programmed into the FPGA 224. Such information may be obtained by subjecting the scintillator 105, the photosensor 107, or the radiation detection apparatus 102 to environmental conditions to which the scintillator 105, the photosensor 107, or the radiation detection apparatus 102 will be exposed. For example, information may be obtained when the radiation detection apparatus 102 is exposed to radiation when exposed to a plurality of temperatures in a range of 100° C. to 250° C. Both the light output of the scintillator 105 and the electronic pulse corresponding to the vibration can be affected by temperature. Further information within the FPGA 224 can also include pulse shape analysis information to help to characterize scintillating pulses to determine the type or source of radiation captured by the scintillator 105.

The radiation detector apparatus 102 may be used after the FPGA 224, another part of the control module 109, or any combination have been programmed or have appropriate information stored in the memory 226, the processor 222, another part of the control module 109, or any combination thereof.

The method can include placing a logging tool into a well bore, at block 402 in FIG. 4. The logging tool can include the sonde 100 as previously described. The method can further include capturing radiation within the scintillator, at block 422, and emitting scintillating light from the scintillator 105 in response to capturing the radiation, at block 424. In a particular embodiment, the radiation can be gamma radiation, a neutron, or a combination of thereof. When gamma radiation is captured, scintillating light is emitted. When a neutron is captured, the neutron sensitive material emits particles, such as an alpha particle and a triton. The scintillator can capture the alpha particle from the neutron sensitive material and emit scintillating light. The method can include generating an electronic pulse at the photosensor 107 in response to receiving the scintillating light, at block 442.

The method can include receiving the electronic pulse at the processor module 109, at block 462, and generating derived information, at block 464. Referring to FIG. 3, the electronic pulse can be in the form of an analog signal as sent by the photosensor 107 and may be in the form of a voltage or current. In a particular embodiment, a current sensor can be used to monitor electron generation within the photosensor 107 or current flowing from the photosensor 107. The electronic pulse can be amplified by the amplifier 202 and converted to a digital signal by the ADC 204. The digital signal is an example of information that is derived from the electronic pulse. The digital signal is received by the processor 222.

The method can further include performing pulse shape analysis, at block 466. In an embodiment, the processor can receive information that includes the current, which corresponds to the intensity of the scintillating light, and time. The information can be transformed into a different domain to determine the intensity of the electronic pulse at different fundamental frequencies. In an embodiment, the transform can be a Fast Fourier Transform (“FFT”), a wavelet transform, a Haar transform, or another suitable transform. FFT may be better suited for scintillators that have relatively higher light output and continuous changes in time, and the wavelet transform may be better suited for scintillators that have relatively lower light output or rapid changes in time. Linearity refers to how well a scintillation crystal approaches perfect linear proportionality between gamma radiation energy and light output. A scintillator having a base composition of LaBr3:Ce may use FFT, and a scintillator having a base composition of CLYC:Ce may use the wavelet transform.

The method can still further include determining the type of radiation, radiation source or both corresponding to the captured radiation, at block 468. The presence of the dopant within the scintillator can significantly help with the determination. When the scintillator is only designed for detecting gamma radiation, an undesired impurity, such as actinium, can be radioactive and emit background alpha particles that can interfere with the detection of gamma radiation from a radiation source separate from the scintillator (e.g., a calibration source).

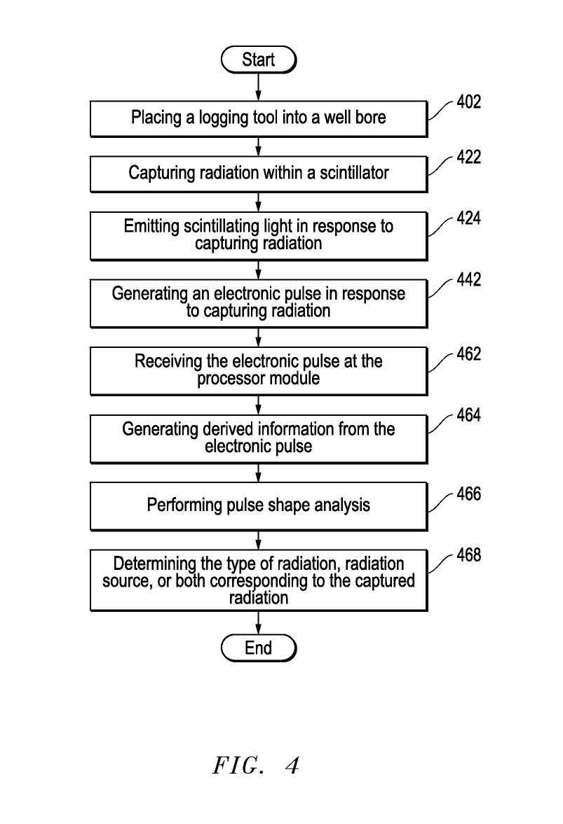

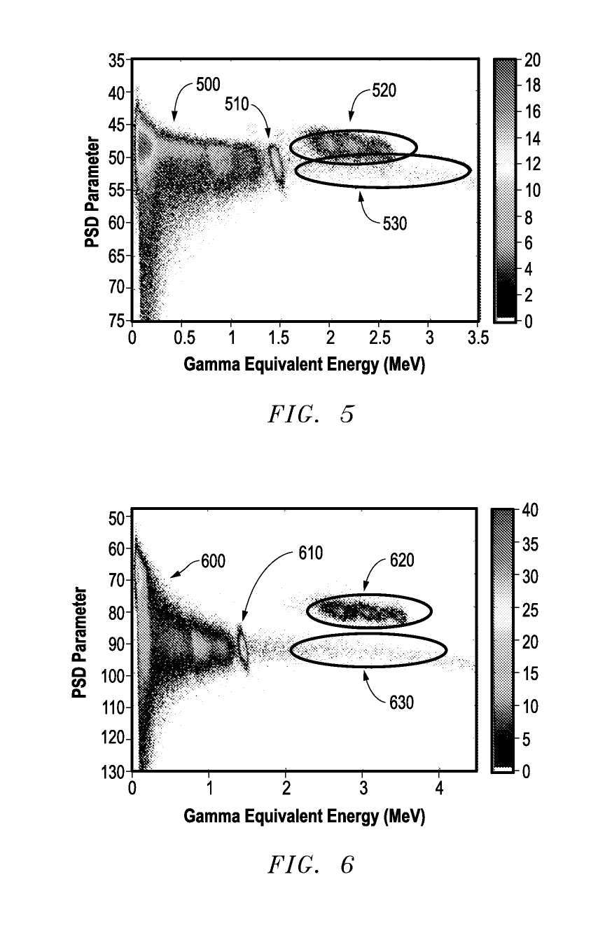

FIGS. 5 and 6 include scatter plots of PSD parameters of scintillation pulses as a function of the Gamma Equivalent Energy of that pulse. FIG. 5 corresponds to a radiation detection apparatus having a scintillator that has a formula of La_{0.95}Ce_{0.05}Br₃ (no co-doping) measuring its own background radiation and the natural environmental radiation. In FIG. 5, data corresponding to lower energy gamma radiation 500 (corresponding to an energy of less than 1.4 MeV), 1.4 MeV gamma radiations from ¹³⁸La 510, alpha radiations from ²²⁷Ac and its daughter particles 520 (background alpha particles for the compositions used for FIGS. 5 and 6), and higher energy gamma radiations 530 and 630, respectively, are labeled. FIG. 6 corresponds to a radiation detection apparatus having a scintillator that has a formula of La_{0.95}Ce_{0.05}Br₃ with 70 ppma of Sr (Sr co-doped). In FIG. 6, data corresponding lower energy gamma radiation 600, 1.4 MeV gamma radiations from ¹³⁸La 610, alpha radiations from ²²⁷Ac and its daughter particles 620, and higher energy gamma radiations 630 are labeled.

In each of FIGS. 5 and 6, lower energy gamma radiation 500 and 600 can be resolved relatively easily from the alpha particles based on their differences in Gamma Equivalent Energies. Referring to FIG. 5, resolving higher energy gamma radiation, such as from ¹³⁸La 510 (1.4 MeV) and natural background gamma radiations 530 at energies in the range of 2 MeV to 4 MeV, from the alpha particles is more difficult. A La-containing scintillator includes Ac as an undesired impurity, and ²²⁷Ac and its daughter particles emit alpha particles that make up background alpha particles 520 in the scintillator, corresponding to the triple peaks also at energies in the range of 2 MeV to 4 MeV. Thus alpha radiation from ²²⁷Ac and its daughter particles 520 cannot be easily separated from the higher energy gamma radiation 530 because they are in a similar energy range. They can only be separated by the PSD Parameter generated by pulse shape discrimination technique. In this case, there is significant overlap between the background alpha particles 520 and the higher energy gamma radiations 530 on FIG. 5. Discrimination between higher energy gamma radiation and alpha particles is relatively difficult.

FIG. 6 demonstrated that doping a base composition of a scintillator can help to discriminate between different types of radiation more readily. In a particular embodiment, LaBr₃:Ce can be co-doped with Sr. As illustrated in FIG. 6, the dopant helps to provide better separation between the higher energy gamma radiation, such as from ¹³⁸La (1.4 MeV) 610 and natural background gamma radiations at energies in the range of 2 MeV to 4 MeV energy 630, from the background alpha particles, corresponding to the triple peaks 620. The overlap between the alpha region 620 and higher energy gamma region 630 is significantly reduced. Therefore, gamma radiation, including higher energy gamma radiation, can be more readily discerned from alpha particles, such as background alpha particles.

The concepts can be extended to discriminating gamma radiation from neutrons when the radiation detection apparatus includes a neutron sensitive material. In a particular embodiment, the scintillators as described with respect to FIGS. 5 and 6 can be surrounded by a LiF powder that includes ⁶Li. If needed or desired, a moderator can be used to convert fast neutrons to thermal neutrons, which can be captured by the ⁶Li to produce an alpha particle and a triton. Similar to the background alpha particles, the alpha particles and the triton particles from the neutron capture reaction on ⁶Li can be captured by the scintillator and emit scintillating light pulse. The scintillation pulses excited by alpha particles and triton particles have different pulse shapes from scintillation pulses excited by gamma radiations thus they have different PSD Parameters. This difference is even more prominent in scintillators with co-doping. The co-doping of the scintillator with Sr can help to separate the portions of the plots corresponding to gamma radiation and alpha and triton particles (from the neutron capture reaction on ⁶Li).

In still another embodiment, the scintillator may include Li or B as part of the base composition of the scintillator. In a particular embodiment, the scintillator has a base composition of CLLB:Ce or CLYC:Ce, wherein part of the Li includes ⁶Li. CLLB:Ce and CLYC:Ce may have a lower light output or less linearity as compared to the scintillators with a base composition of LaBr3:Ce. The pulse shape analysis may be performed using a wavelet transform.

With respect to wavelet discrimination, wavelets are functions that satisfy certain mathematical requirements and are used in representing data or other functions. In wavelet discrimination, an analysis is based on a basis wavelet function, also called a mother wavelet. The pulse is then represented as a linear combination of a series of the mother wavelet functions. In an embodiment, the mother wavelet is a Haar wavelet. In another embodiment, a Morlet wavelet, a Meyer wavelet, a Mexican hat wavelet, a Daubechies wavelet, a Coiflet wavelet, a Symlet wavelet, a Paul wavelet, a Difference of Gaussians wavelet, a customized wavelet, or another suitable wavelet may be used.

Each mother wavelet can be characterized by three coefficients:

1) s: Scale factor (This defines the width of the wavelet);

2) t: Location (This defines the location of the wavelet; in a particular embodiment, position is time, t.); and

3) a: Amplitude.

After wavelet transformation, a signal (for example, a digitized scintillation pulse, x-y pairs of amplitude and time) can be represented as a series of s, t and a coefficients. Thus, suitable pulse shape discrimination (“PSD”) parameters can be generated from the pulse, wherein the PSD parameters are based on the wavelet coefficients. A benefit of wavelet discrimination is that it is especially good for fast (sharp) pulses, as it gives good separation. Further, it is substantially insensitive to stochastic noise. Further, it is substantially insensitive to a false signal caused by signal reflection or discontinuities in the cable. Still further, it is substantially insensitive to a false signal caused by electromagnetic interference from nearby electronics or other electromagnetic signal source.

A non-limiting embodiment of wavelet discrimination is provided to illustrate how wavelet discrimination can be used in analyzing a pulse from the photosensor 107. In this embodiment, an electronic pulse has been converted to a digital pulse, and the mother wavelet is a Haar wavelet. The output for wavelet transform is a matrix that contains series of s, t, and a values. Because a is a complex number (due to phase difference among basis wavelets), a power of a is used to represent the absolute magnitude of that basis wavelet. The coefficient t is used as the x axis, the coefficient s is used as the y axis, and |a|² is used as the z-axis. Thus, a power spectrum of a wavelet transform of signal can be plotted.

Further, a Wavelet PSD Parameter may be calculated based on the s, t, and a coefficients from the wavelet transform. In an illustrative, non-limiting embodiment, the Wavelet PSD Parameter is calculated using the equations below

$$Wavelet P S D parameter = \frac{{Integration}_{ 1}}{{Integration }_{2}} ;$$

wherein Integration₁ is:

Integration₁=∫_{t1 lower}^{t1 upper}∫_{s1 lower}^{s1 upper}|a|²dsdt; and

wherein Integration₂ is:

Integration₂=∫_{t2 lower}^{t2 upper}∫_{s2 lower}^{s2 upper}|a|²dsdt

In a particular, the values used for the integration may be, for Integration₁: s1 upper is 650, s1 lower is 200, t1 upper is 575, and t1 lower is 525; and, for Integration₂, s2 upper is 1000, s2 lower is 700, t2 upper is 1100, and t2 lower is 1. For a pulse generated by the photosensor 107, the Wavelet PSD Parameter and other information can be used to determine what type of radiation or radiation source corresponds to radiation captured by the radiation detection apparatus.

In an embodiment, the control module 109 may be limited in resources, such as processer speed, memory size or number of gates and RAMs in FPGA. Discrete Wavelet Transform may be used to reduce the computation load to ensure high processing speed.

In a particular embodiment, discrete wavelet transform using Haar mother wavelet is used. Wavelet PSD Parameter is calculated based on the coefficients from the discrete wavelet transform.

Similar to the scintillators with a base composition of LaBr3:Ce, co-doping a scintillator with a different base composition, such as CLLB:Ce and CLYC:Ce, can help to provide better separation between the alpha particles and gamma radiation.

Another pulse shape analysis technique may be used. In a particular embodiment, the pulse shape analysis may be performed using a ratio of a first integrated portion of the pulse during a first part of pulse to a second integrated portion of the pulse during a second part of the pulse. For example, the pulse can be integrated from the time the pulse is initially sensed to a time that is no greater than 50 ns after the pulse is initially sensed. In a particular embodiment, the pulse can be integrated to determine the charge received from the photosensor 107 from t₁ₛ=0 to t₁ₑ=50 ns. Regarding the second part of the pulse, it can start at a time that is at least 200 ns after the pulse is initially sensed. The second part of the pulse corresponds may end at a time that is no greater than 2000 ns after the pulse is initially sensed. In a particular embodiment, the pulse can be integrated to determine the charge received from the photosensor 107 from t₂ₛ=200 to t₂ₑ=2000 ns. The ratio of the integrated parts of the pulse can be used to determine the type or source of radiation.

In another embodiment, the pulse shape analysis may be performed by using an integrated pulse over a predetermined time interval. In an embodiment, the predetermined time interval is for a period of 10% to 90% of a total pulse time, and in another time, the predetermined time interval is for a period of 80% to 90% of a total pulse time. The former may be suitable for one type of scintillator material, and the latter may be suitable for another type of scintillator material. The integrated pulse can be compared to data for different radiation types or sources of radiation.

Other actions may be performed if needed or desired. In an embodiment, a counter may be used to track radiation counts. After classification, a neutron counter or a gamma radiation counter can be incremented. Further any of the information received by or generated within the control unit may be transmitted through the I/O 242.

After reading this specification, skilled artisans will appreciate that other configurations may be used. Some or all of the functions described with respect to the FPGA 224 may be performed by the processor 222, and therefore, the FPGA 224 is not required in all embodiments. Further, the FPGA 224, the memory 226, the I/O module 242, or any combination thereof may be within the same integrated circuit, such as the processor 222. In a further embodiment, the control module 109 does not need to be housed within the radiation detection apparatus 102. The control module 109 may be outside the well bore. Still further, at least one component of the control module 109, as illustrated in FIG. 2 may be within the radiation detection apparatus 102 and at least one other component may be outside the radiation detection apparatus 102, such as outside the well bore. In well-logging applications, information from the devices close to the distal end of the drill string, such as the radiation detection apparatus 102, may take approximately 0.5 to approximately 5 minutes to reach the surface. The control module 109 within the radiation detection apparatus 102 can allow operations to proceed quickly without having data transmission delays.

After reading this specification, skilled artisans will understand that the concepts as described herein are not limited to well logging. The scintillators and pulse shape analysis modules can be used in radiation detection for medical imaging, port-of-entry detectors, scientific research, or the like.

The synergistic combination of a particular dopant in a scintillator's base composition and a pulse shape analysis module can allow for significantly better discrimination between different targeted radiation, as compared to using the scintillator having the base composition without the particular dopant. In a particular embodiment, a scintillator with the particular dopant can aid in the separation of data corresponding to gamma radiation and alpha particles. The separation allows discrimination between gamma radiation and alpha particles to occur more readily and with a higher level of confidence that the radiation captured by the scintillator is properly identified. The concepts as described herein are not limited to any particular dopant or base composition and are not limited to any particular types of radiation or radiation sources. The concepts can be useful regarding scintillators that include undesired impurities that emit radiation that can interfere with radiation from a radiation source separate from the scintillator. Further, the concepts can help to improve the performance of a dual mode radiation detection apparatus to allow for classification of different types of radiation with a greater confidence level.

Many different aspects and embodiments are possible. Some of those aspects and embodiments are described herein. After reading this specification, skilled artisans will appreciate that those aspects and embodiments are only illustrative and do not limit the scope of the present invention. Additionally, those skilled in the art will understand that some embodiments that include analog circuits can be similarly implemented using digital circuits, and vice versa. Embodiments may be in accordance with any one or more of the items as listed below.

Item 1. A radiation detection apparatus comprising:
a scintillator having a base composition and including a first dopant, wherein the scintillator is sensitive to a first targeted radiation and a second targeted radiation;
a neutron sensitive material adjacent to scintillator;
a photosensor optically coupled to the scintillator; and
a control module coupled to the photosensor, wherein the control module comprises a pulse shape analysis module that can more readily discriminate between the first targeted radiation and second targeted radiation when the radiation detection apparatus has the scintillator as compared to a different scintillator having the base composition without the first dopant.

Item 2. The radiation detection apparatus of Item 1, wherein the radiation detection apparatus does not include a neutron sensitive material.

Item 3. The radiation detection apparatus of Item 1, wherein the scintillator further comprises a neutron sensitive material.

Item 4. The radiation detection apparatus of Item 1, wherein the scintillator further comprises a neutron sensitive material adjacent to scintillator.

Item 5. The radiation detection apparatus of any one of the preceding Items, wherein the first targeted radiation has a type of radiation that is gamma radiation.

Item 6. The radiation detection apparatus of any one of the preceding Items, wherein the second targeted radiation is a background alpha particle.

Item 7. The radiation detection apparatus of any one of Items 1, and 3 to 6, wherein the second targeted radiation is a neutron.

Item 8. The radiation detection apparatus of any one of the preceding Items, wherein the first dopant comprises an element that is different from elements within the base composition.

Item 9. The radiation detection apparatus of any one of the preceding Items, wherein the first dopant comprises a divalent element.

Item 10. The radiation detection apparatus of any one of the preceding Items, wherein the first dopant includes a Group 2 element.

Item 11. The radiation detection apparatus of any one of the preceding Items, wherein the first dopant includes Sr, Ba, or a combination thereof.

Item 12. The radiation detection apparatus of any one of the Items 1 to 8, wherein the first dopant comprises a monovalent element.

Item 13. The radiation detection apparatus of any one of the Items 1 to 8 and 12, wherein the first dopant includes a Group 1 element.

Item 14. The radiation detection apparatus of any one of the Items 1 to 8, 12, and 13, wherein the first dopant includes Li, Na, or a combination thereof.

Item 15. The radiation detection apparatus of any one of the Items 1 to 8 and 12 to 14, wherein the first dopant includes Li, wherein Li has a naturally occurring amount of ⁶Li.

Item 16. The radiation detection apparatus of any one of Items 1 to 8, wherein the first dopant includes B, Bi, or a combination thereof.

Item 17. The radiation detection apparatus of Items 1 to 8 and 16, wherein the first dopant includes B, wherein B has a naturally occurring amount of ¹⁰B.

Item 18. The radiation detection apparatus of any one of the preceding Items, wherein the first dopant has a concentration of at least 10 ppma, at least 20 ppma, at least 50 ppma, or at least 110 ppma.

Item 19. The radiation detection apparatus of any one of the preceding Items, wherein the first dopant has a concentration of no greater than 1000 ppma, no greater than 700 ppma, no greater than 500 ppma, or at no greater than 300 ppma.

Item 20. The radiation detection apparatus of any one of the preceding Items, wherein the first dopant has a concentration in a range of 10 ppma to 1000 ppma, 20 ppma to 700 ppma, or 50 ppma to 500 ppma.

Item 21. The radiation detection apparatus of any one of the preceding Items, wherein the base composition comprises a second dopant.

Item 22. The radiation detection apparatus of Item 21, wherein the second dopant is an activator for the scintillator.

Item 23. The radiation detection apparatus of Item 21 or 22, wherein the second dopant comprises a rare earth element.

Item 24. The radiation detection apparatus of any one of Items 21 to 23, wherein the rare earth element is Ce, Pr, or Tb.

Item 25. The radiation detection apparatus of any one of Items 21 to 24, wherein the rare earth element is Eu or Sm.

Item 26. The radiation detection apparatus of any one of Items 21 to 25, wherein the second dopant has a concentration of at least 10 ppma, at least 20 ppma, at least 50 ppma, or at least 110 ppma.

Item 27. The radiation detection apparatus of any one of Items 21 to 26, wherein the second dopant has a concentration of no greater than 1000 ppma, no greater than 700 ppma, no greater than 500 ppma, or at no greater than 300 ppma.

Item 28. The radiation detection apparatus of any one of Items 21 to 27, wherein the second dopant has a concentration in a range of 10 ppma to 1000 ppma, 20 ppma to 700 ppma, or 50 ppma to 500 ppma.

Item 29. The radiation detection apparatus of any one of the preceding Items, wherein the base compound comprises a rare earth metal halide, a rare earth oxide, a rare earth silicate, a rare earth aluminate, or a rare earth oxysulfide.

Item 30. The radiation detection apparatus of any one of the preceding Items, wherein the base compound comprises an elpasolite.

Item 31. The radiation detection apparatus of any one of the preceding Items, wherein the base compound comprises a rare earth metal halide.

Item 32. The radiation detection apparatus of any one of the preceding Items, wherein the base compound has a general formula of REX₃, wherein RE is one or more rare earth elements, and X is one or more halogens.

Item 33. The radiation detection apparatus of any one of the preceding Items, wherein the base compound has a formula of La₍₁₋ₐ₎CeₐBr_{3(1-c)}Cl_{3c}, wherein 0≦a≦1, and 0≦c≦1.

Item 34. The radiation detection apparatus of Item 33, wherein the 0<a.

Item 35. The radiation detection apparatus of Item 33 or 34, wherein the 0<a≦0.4.

Item 36. The radiation detection apparatus of any one of Items 22 to 34, wherein a=1.

Item 37. The radiation detection apparatus of any one of Items 33 to 36, wherein c=0.

Item 38. The radiation detection apparatus of any one of Items 33 to 36, wherein c=1.

Item 39. The radiation detection apparatus of any one of Items 1 to 31, wherein the base compound has a general formula of M₃REX₆ or MRE₂X₇, wherein M is one or more Group 1 elements, RE is one or more rare earth elements, and X is one or more halogens.

Item 40. The radiation detection apparatus of any one of Items 1 to 31 and 39, wherein the base compound has a formula of Cs₂LiLa_{(1-a-b)}YₐCe_{b}Br_{6(1-c)}Cl_{6c}, wherein 0≦a≦1, 0≦b≦0.05, and 0≦c≦1.

Item 41. The radiation detection apparatus of Item 40, wherein a=0.

Item 42. The radiation detection apparatus of Item 40, wherein a+b=1.

Item 43. The radiation detection apparatus of any one of Items 40 to 42, wherein b=0.

Item 44. The radiation detection apparatus of any one of Items 40 to 42, wherein 0.0001≦b≦0.1.

Item 45. The radiation detection apparatus of any one of Items 40 to 44, wherein c=0.

Item 46. The radiation detection apparatus of any one of Items 40 to 44, wherein c=1.

Item 47. The radiation detection apparatus of any one of Items 1 and 3 to 46, wherein neutron sensitive material comprises ⁶Li.

Item 48. The radiation detection apparatus of any one of Items 1 and 3 to 47, wherein neutron sensitive material comprises ⁶LiF.

Item 49. The radiation detection apparatus of any one of Items 1 and 3 to 46, wherein neutron sensitive material comprises ¹⁰B.

Item 50. The radiation detection apparatus of any one of Items 1, 3 to 46, and 49, wherein neutron sensitive material comprises ¹⁰B in elemental form, ¹⁰BN, ¹⁰B₄C, ¹⁰B₂O₃, or any combination thereof.

Item 51. The radiation detection apparatus of any one of Items 4 to 50, wherein neutron sensitive material laterally surrounds the scintillator.

Item 52. The radiation detection apparatus of any one of Items 3 to 51, wherein neutron sensitive material is not embedded within a polymer matrix.

Item 53. The radiation detection apparatus of any one of Items 3 to 52, wherein the neutron sensitive material is not suspended within a liquid.

Item 54. The radiation detection apparatus of any one of Items 4 to 53, wherein neutron sensitive material is in a form of a film.

Item 55. The radiation detection apparatus of any one of Items 4 to 53, wherein neutron sensitive material is in a form of a powder.

Item 56. The radiation detection apparatus of any one of Items 4 to 55, wherein neutron sensitive material is in direct contact with the scintillator.

Item 57. The radiation detection apparatus of any one of Items 4 to 55, wherein neutron sensitive material, wherein a gas is disposed between the neutron sensitive material and the scintillator.

Item 58. The radiation detection apparatus of any one of the preceding Items, wherein:
the scintillator is configured to generate scintillating light is response to capturing radiation;
the photosensor is configured to generate a pulse in response to receiving scintillating light; and
the control module is configured to generate derivative information from the pulse.

Item 59. The radiation detection apparatus of any one of the preceding Items, wherein the control module is configured to perform a Fast Fourier Transform, or a wavelet transform.

Item 60. The radiation detection apparatus of any one of the preceding Items, wherein the control module is configured to perform a Fast Fourier Transform.

Item 61. The radiation detection apparatus of any one of the preceding Items, wherein the control module is configured to perform a wavelet transform.

Item 62. The radiation detection apparatus of any one of the preceding Items, wherein the control module is configured to perform a discrete wavelet transform.

Item 63. The radiation detection apparatus of Item 61 or 62, wherein the wavelet transform is capable of being performed using a mother wavelet that is a Haar wavelet.

Item 64. The radiation detection apparatus of Item 61 or 62, wherein the wavelet transform is capable of being performed using a mother wavelet that is a Morlet wavelet, a Meyer wavelet, a Mexican hat wavelet, a Daubechies wavelet, a Coiflet wavelet, a Symlet wavelet, a Paul wavelet, a Difference of Gaussians wavelet, or a customized wavelet.

Item 65. The radiation detection apparatus of Items 61 to 64, wherein the wavelet transform is performed on derivative information that includes a Fast Fourier Transform

Item 66. The radiation detection apparatus of any one of the preceding Items, wherein the control module is configured to perform pulse shape analysis using a ratio of a first integrated portion of the pulse during a first part of pulse to a second integrated portion of the pulse during a second part of the pulse.

Item 67. The radiation detection apparatus of Item 66, wherein the first part of the pulse ends at a time that is no greater than 50 ns after the pulse is initially sensed.

Item 68. The radiation detection apparatus of Item 66 or 67, wherein the wherein the second part of the pulse starts at a time that is at least 200 ns after the pulse is initially sensed.

Item 69. The radiation detection apparatus of Item 66, wherein the second part of the pulse ends at a time that is no greater than 2000 ns after the pulse is initially sensed.

Item 70. The radiation detection apparatus of any one of the preceding Items, wherein the control module is configured to perform pulse shape analysis using an integrated pulse over a predetermined time interval.

Item 71. The radiation detection apparatus of Item 70, wherein the predetermined time interval is for a period of 10% to 90% of a total pulse time.

Item 72. The radiation detection apparatus of Item 70, wherein the predetermined time interval is for a period of 80% to 90% of a total pulse time.

Item 73. The radiation detection apparatus of any one of the preceding Items, further comprising a multichannel analyzer, wherein different channels of the multichannel analyzer correspond to different energies of photons.

Item 74. A method of using the radiation detection apparatus of any one of the preceding Items comprising:
capturing a particular radiation at the scintillator;
emitting scintillating light from the scintillator in response to capturing the particular radiation;
generating a pulse at the photosensor in response to receiving the scintillating light;
processing the pulse, wherein processing includes generating derivative information corresponding to the pulse, and transforming the derivative information; and
determining whether the particular radiation corresponds to the first targeted information or the second targeted radiation.

Item 75. The method of Item 74, wherein the first dopant helps to discriminate between background alpha particles emitted by the scintillator from gamma radiation captured by the scintillator.

Item 76. The method of Item 75, wherein the particular radiation is the gamma radiation, and the scintillator produces a signal corresponding to an energy of at least 1.4 MeV, at least 1.7 MeV, or at least 2.0 MeV in response to capturing the gamma radiation.

Item 77. The method of Item 74, wherein the first dopant helps to discriminate between gamma radiation and neutrons.

Item 78. The method of Item 77, wherein the particular radiation is the gamma radiation, and wherein the scintillator produces a signal corresponding to an energy of at least 1.4 MeV, at least 1.7 MeV, or at least 2.0 MeV in response to capturing the gamma radiation.

### Examples

The examples below demonstrate that co-doping a scintillator can allow a radiation detection apparatus to detect neutrons in addition to gamma radiation. The examples are illustrative and do not limit the scope of the present invention.

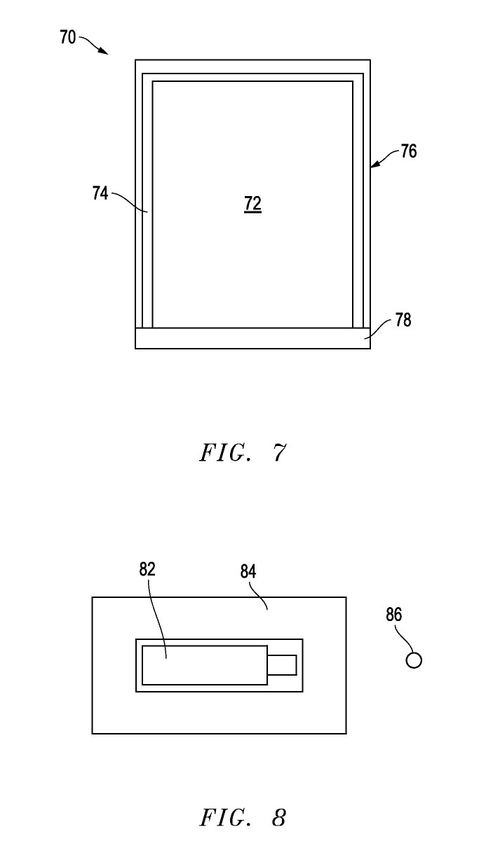

FIG. 7 includes an illustration of a detector 70 used with the examples. The detector 70 included a scintillator 72, a neutron sensitive material 74, a housing 76 and a window 78 that can be optically coupled to a photosensor (not illustrated). The scintillator 72 had a diameter of approximately 2.5 cm and a length of approximately 2.5 cm. The neutron sensitive material 74 and a light reflector, such as the housing 76, surrounded all sides of the scintillator 72 except the side facing the window 78. In the examples, the neutron sensitive material was a 2 mm thick layer that included enriched ⁶LiF. The scintillator 72 and neutron sensitive material 74 were enclosed within the housing 76.

FIG. 8 includes an illustration of a neutron test set up having a radiation detection apparatus 82 that included the detector 70, a neutron moderator 84, and a neutron source 86. The neutron moderator 84 converted fast neutrons into thermal neutrons. One example of such neutron moderator is high density polyethylene. The neutron source 86 included ²⁵²Cf.

An example detector was used to test for detecting neutrons. The scintillator 72 had a formula of La_{0.95}Ce_{0.05}Br₃ with 70 ppma of Sr (Sr co-doped). The detector was tested for gamma radiation to confirm that the neutron sensitive material 74 did not affect gamma radiation sensed by the detector.

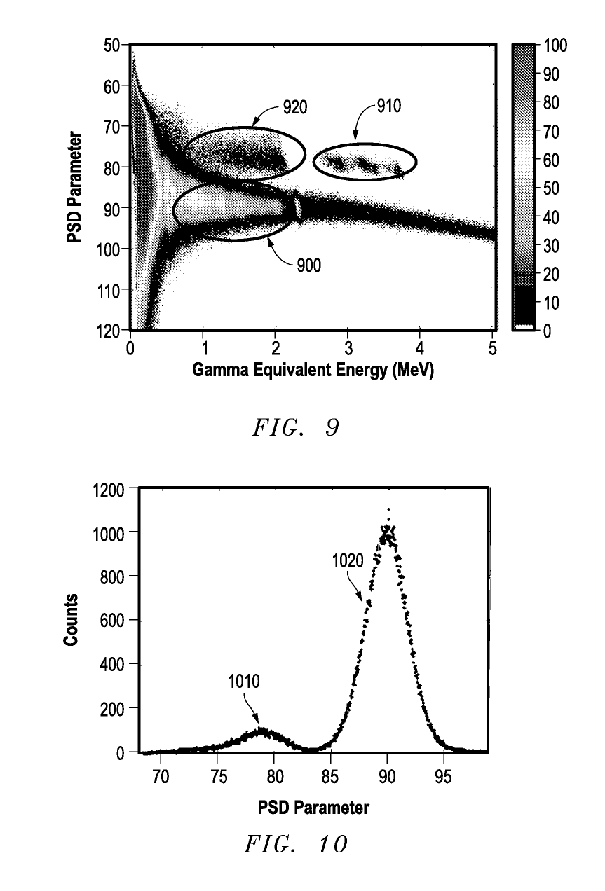

FIG. 9 includes a scatter plot of PSD Parameter versus Gamma Equivalent Energy. Regarding the PSD parameter, smaller values correspond to faster pulses. In FIG. 9, data corresponding to lower energy gamma radiation 900, 1.4 MeV gamma radiations from alpha radiations from ²²⁷Ac and its daughter particles 910, and neutron radiation 920 (scintillation pulses excited by the tritons from neutron capture reaction on ⁶Li) are labeled. The Gamma Equivalent Energies of neutron induced triton particles are lower than those of the alpha particles from ²²⁷AC and its daughter particles. The neutron region 920 is located left to the ²⁷⁷Ac alpha particles 910. There is a clear separation between the low energy gamma 900 and neutron radiation 920.

FIG. 10 illustrates the PSD spectrum of the neutron radiations and gamma radiations in the example detector. FIG. 10 shows the distribution of all scintillation pulses in the energy window corresponding to that of neutron radiation 920 in FIG. 9. As can be seen in FIG. 10, the peak 1010 corresponding to neutron radiations (scintillation pulses excited by the tritons from neutron capture reaction on ⁶Li) is clearly separated from the peak 1020 corresponding to gamma radiations. The figure of merit of gamma-neutron pulse shape discrimination for this example detector is 1.22. The neutron peak and the gamma peak can be readily resolved.

Note that not all of the activities described above in the general description or the examples are required, that a portion of a specific activity may not be required, and that one or more further activities may be performed in addition to those described. Still further, the order in which activities are listed is not necessarily the order in which they are performed.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

1. A radiation detection apparatus comprising:
a scintillator having a base composition and including a first dopant, wherein the scintillator is sensitive to a first targeted radiation and a second targeted radiation;
a neutron sensitive material adjacent to scintillator;
a photosensor optically coupled to the scintillator; and
a control module coupled to the photosensor, wherein the control module comprises a pulse shape analysis module that can more readily discriminate between the first targeted radiation and second targeted radiation when the radiation detection apparatus has the scintillator as compared to a different scintillator having the base composition without the first dopant.

2. The radiation detection apparatus of claim 1, wherein the scintillator further comprises a neutron sensitive material.

3. The radiation detection apparatus of claim 1, wherein the first targeted radiation has a type of radiation that is gamma radiation.

4. The radiation detection apparatus of claim 3, wherein the second targeted radiation is a background alpha particle.

5. The radiation detection apparatus of claim 3, wherein the second targeted radiation is a neutron.

6. The radiation detection apparatus of claim 1, wherein the first dopant includes a Group 2 element.

7. The radiation detection apparatus of claim 1, wherein the first dopant includes Sr, Ba, or a combination thereof.

8. The radiation detection apparatus of claim 1, wherein the first dopant has a concentration of at least 10 ppma, at least 20 ppma, at least 50 ppma, or at least 110 ppma.

9. The radiation detection apparatus of claim 1, wherein the first dopant has a concentration of no greater than 1000 ppma, no greater than 700 ppma, no greater than 500 ppma, or at no greater than 300 ppma.

10. The radiation detection apparatus of claim 1, wherein the base composition comprises a second dopant, and wherein the second dopant is an activator for the scintillator.

11. The radiation detection apparatus of claim 10, wherein the second dopant has a concentration in a range of 10 ppma to 1000 ppma, 20 ppma to 700 ppma, or 50 ppma to 500 ppma.

12. The radiation detection apparatus of claim 1, wherein the base compound comprises a rare earth metal halide, a rare earth oxide, a rare earth silicate, a rare earth aluminate, or a rare earth oxysulfide.

13. The radiation detection apparatus of claim 1, wherein the base compound comprises an elpasolite.

14. The radiation detection apparatus of claim 1, wherein the base compound has a general formula of REX₃, wherein RE is one or more rare earth elements, and X is one or more halogens.

15. The radiation detection apparatus of claim 1, wherein neutron sensitive material comprises ⁶Li or ¹⁰B.

16. The radiation detection apparatus of claim 1, wherein the control module is configured to perform a Fast Fourier Transform, or a wavelet transform.

17. The radiation detection apparatus of claim 1, wherein the control module is configured to perform pulse shape analysis using a ratio of a first integrated portion of the pulse during a first part of pulse to a second integrated portion of the pulse during a second part of the pulse.

18. The radiation detection apparatus of claim 17, wherein the first part of the pulse ends at a time that is no greater than 50 ns after the pulse is initially sensed.

19. A method of using the radiation detection apparatus claim 1 comprising:
capturing a particular radiation at the scintillator;
emitting scintillating light from the scintillator in response to capturing the particular radiation;
generating a pulse at the photosensor in response to receiving the scintillating light;
processing the pulse, wherein processing includes generating derivative information corresponding to the pulse, and transforming the derivative information; and
determining whether the particular radiation corresponds to the first targeted information or the second targeted radiation.

20. The method of claim 19, wherein the first dopant helps to discriminate between background alpha particles emitted by the scintillator from gamma radiation captured by the scintillator.
